(19) United States
(12) Patent Application Publication
(10) Pub. No.: US 2012/0276502 A1
(43) Pub. Date: Nov. 1, 2012

(54) DESIGN AND MANUFACTURE OF DENTURES

(75) Inventor: MICHAEL CRAIG MARSHALL, Prior Lake, MN (US)

(73) Assignee: GeoDigm Corporation, Falcon Heights, MN (US)

(21) Appl. No.: 13/457,571

(22) Filed: Apr. 27, 2012

Related U.S. Application Data
(60) Provisional application No. 61/480,396, filed on Apr. 29, 2011.

(51) Int. Cl. A61C 13/00; G05B 19/18; G06F 17/50

(52) U.S. Cl. 433/199.1; 703/1; 700/97; 433/201.1

(57) ABSTRACT

Manufacturing dentures for a patient includes preparing a dentition plan; designing dentures based on the dentition plan; and fabricating the dentures. To fabricate the dentures, one or more patterns of the dentures may be produced, tooth substitutes may be assembled on the pattern, and one or more denture bases may be cast around the tooth substitutes from the patterns. Alternatively, tooth substitutes may be installed on denture bases that are milled or otherwise fabricated. The roots of the tooth substitutes may be modified to better fit in the designed dentures.

### CROSS REFERENCE TO RELATED APPLICATION

This application claims the benefit of U.S. Provisional Application No. 61/480,396, filed Apr. 29, 2011, and titled “Design and Manufacture of Dentures,” the disclosure of which is hereby incorporated herein by reference.

### BACKGROUND

Computer based systems that allow the creation and use of electronic models of teeth to design some types of dental appliances have been developed over time. Electronic models of dental appliances are designed to fit within the patient's mouth and then fabricated to produce the appliance or a pattern used in casting the appliance.

In some prior systems, an electronic model for a dental appliance is designed to complement an electronic image of a preparation site within the patient's mouth. The electronic image of the preparation site can be generated based on a patient's actual preparation site (e.g., through intra-oral imaging) or a casting thereof (e.g., a dental study cast). In an embodiment, the electronic model of the dental appliance is generated based on an electronic image of a neighboring tooth. The electronic image is then edited to fit on the preparation site.

In another embodiment, a standard electronic model is obtained from an image library. The electronic model can be edited manually using an interactive computer graphics program. For example, sections of the electronic model can be selected and dragged into desired shapes using standard graphic editing techniques. New lines or sections can be added and undesired sections can be deleted from the electronic model. Such editing can be time-consuming and depends on the skill of the technician to create a visually pleasing dental appliance that will fit the space.

It is with respect to these and other considerations that the present invention has been made.

### SUMMARY

The disclosure relates to designing and fabricating manufacturing aids for use in manufacturing dental prostheses. More particularly, the disclosure relates to the design and fabrication of denture arches (temporary and/or permanent) and jigs suitable for use in producing the same. Some aspects of the disclosure relate to design and/or manufacturing a customized denture arch to accommodate tooth substitutes arranged according to a customized dentition plan. Some aspects of the disclosure relate to customizing tooth substitutes for the denture arches.

### BRIEF DESCRIPTION OF THE DRAWINGS

Referring to the drawing, wherein like numerals represent like parts throughout the several views:

FIG. 1 is a front elevational view of an example set of denture arches that may be designed and fabricated using the techniques disclosed herein;

FIG. 2 is a side elevational view of an example maxillary denture arch that may be designed and fabricated using the techniques disclosed herein;

FIG. 3 is a side elevational view of an example mandibular denture arch that may be designed and fabricated using the techniques disclosed herein;

FIG. 4 illustrates an example design and production system on which example processes of the present disclosure can be executed;

FIG. 5 is a flowchart illustrating a flow for an example denture design process that can be used to design one or more denture arches for a patient in accordance with the principles of the present disclosure;

FIG. 6 is a side elevational view of example tooth substitute electronic models positioned relative to example dental arch models in accordance with an example dentition plan in accordance with the principles of the present disclosure;

FIG. 7 is a schematic view of example denture base electronic models positioned over the dental arch models of FIG. 6;

FIG. 8 is a flowchart illustrating a flow for an example preparation process by which the prepare operation of FIG. 5 may be implemented;

FIG. 9 is a flowchart illustrating an operational flow for an example digitizing process by which an electronic model of a dental arch may be obtained;

FIG. 10 is a perspective view of an example electronic model of mandibular dental arch and an electronic model of a maxillary dental arch;

FIG. 11 is a front elevational view of the electronic models of FIG. 10 shown positioned in an opposing relationship;

FIG. 12 is a flowchart illustrating an operational flow for an example denture base design process by which an electronic model of a denture base may be obtained;

FIG. 13 is a flowchart illustrating a flow for an example manufacturing process that can be used to manufacture a denture arch for a patient;

FIG. 14 is a flowchart illustrating a flow for an example modification process that can be used to modify the root portion a tooth substitute to fit in the denture base;

FIG. 15 is a side elevational view of an example denture base and tooth substitute electronic models positioned according to a dentition plan showing a tool path for eliminating excess material at the roots of the tooth substitutes;

FIG. 16 is a schematic side elevational view of an electronic model of an example jig that is shaped and sized to accommodate the crowns of the tooth substitute models;

FIG. 17 is a schematic diagram of an example jig including sockets for holding tooth substitutes to aid in the removal of excess material from the roots of the tooth substitutes;

FIG. 17A is a schematic diagram of an example jig including tooth substitutes being held within sockets by drawing a vacuum through one or more vacuum tubes defined in the jig;

FIG. 18 is a schematic depiction of a plurality of tooth substitutes positioned crown-side down in the jig sockets;

FIG. 19 is a flowchart illustrating a flow for an example adjustment process that can be used to modify the gingival interface portion of the denture bases to fit the healed gingival surface of the patient;

FIGS. 20-22 illustrate steps of the adjustment process of FIG. 19 as performed to an example mandibular dental arch; and

FIG. 23 is a flowchart illustrating a flow for another example manufacturing process that can be used to manufacture a denture arch for a patient.

### DETAILED DESCRIPTION

The present disclosure provides for devices and techniques to aid in the manufacture of dental prostheses. In particular, the disclosure relates to the design and fabrication of dental dentures or other dental prostheses. Dental dentures include a base holding one or more tooth substitutes configured to look like the dentition of a patient. The dental dentures are designed to fit over edentulous arches of the patient.

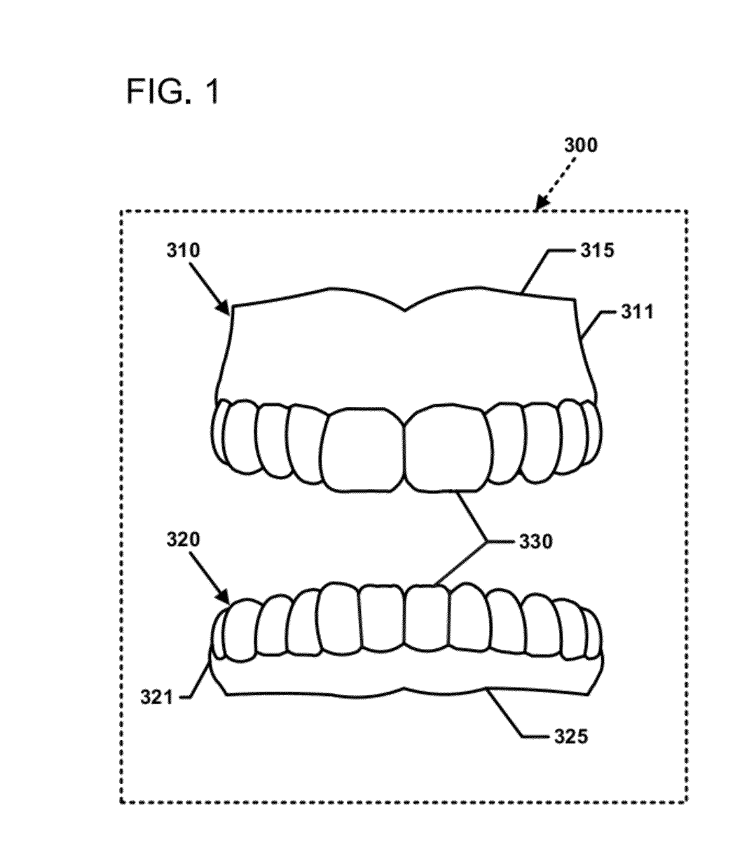

FIG. 1 is a front elevational view of an example set of dentures 300 that may be designed and fabricated using the techniques disclosed herein. In the example shown, the set of dentures 300 includes an upper arch denture 310 and a lower arch denture 320. In certain implementations, however, it may be desirable to design and manufacture only one denture arch or a portion thereof. Each denture arch 310, 320 includes a plurality of tooth substitutes 330 extending from a base 311, 321. For example, the tooth substitutes 330 may be molded into the respective base 311, 321 of each denture 310, 320.

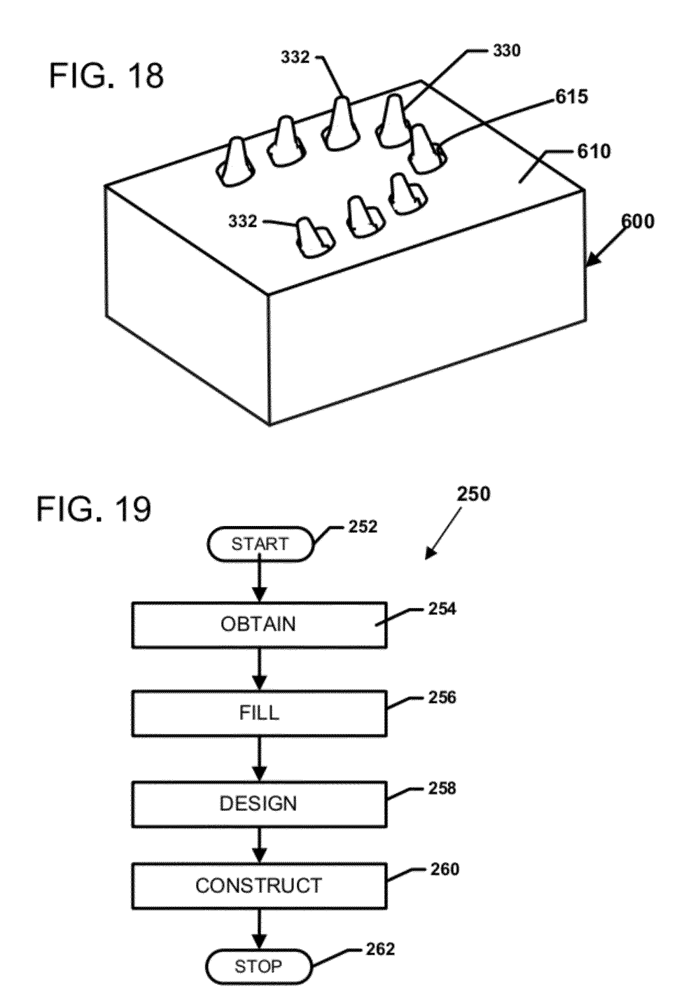

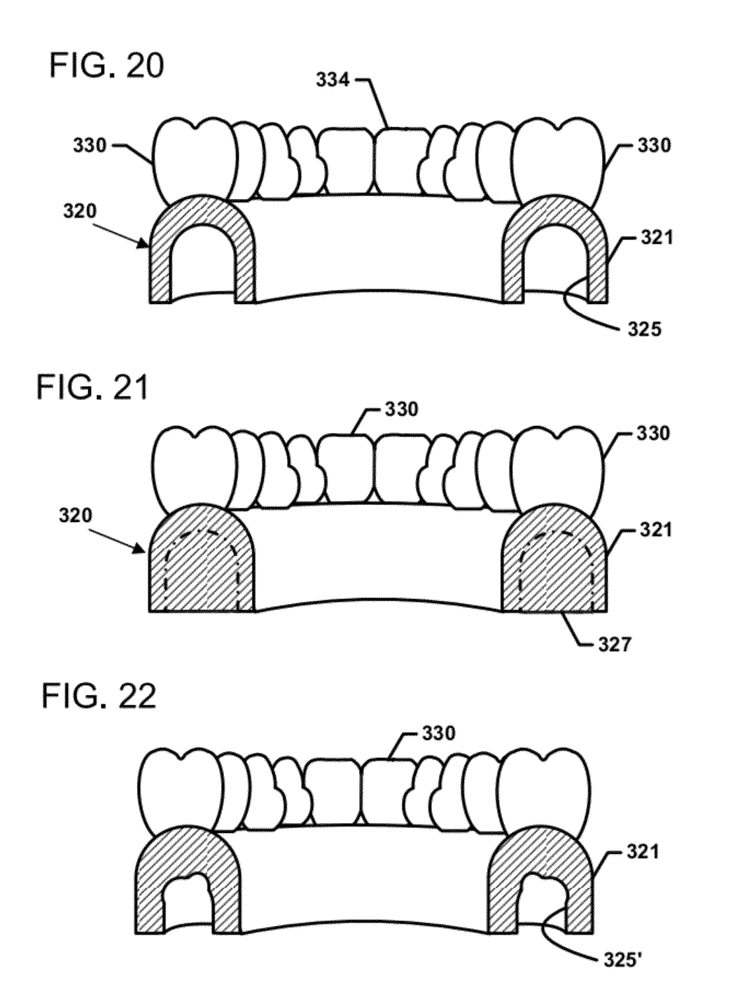

Each tooth substitute 330 corresponds with a tooth missing from the patient (e.g., a central incisor tooth, a lateral incisor tooth, a cuspid, a bicuspid, or a molar). Each tooth substitute 330 includes a root section 332 (FIG. 18) and a crown section 334 (FIG. 20). The root sections 332 of the tooth substitutes 330 are attached to the denture bases 311, 321. In some implementations, the denture bases 311, 321 are sized, shaped, and colored to visually mimic a gingival surface of the patient. For example, each denture base 311, 321 may include a labial gingival surface that is sized and shaped to cover at least part of the patient's actual gingival surface on the labial side. Each denture base 311, 321 also includes an attachment section 315, 325, respectively, that fits over the patient's edentulous dentition when the denture base 311, 321 is installed on the patient (see FIG. 20).

In some implementations, each denture 310, 320 includes a full complement of tooth substitutes 330 to cover the entire dentition over which the denture 310, 320 is mounted. For example, in some implementations, a full dental arch may include twelve to sixteen tooth substitutes 330. In other implementations, however, the base 311, 321 may include one or more gaps to enable remaining real teeth of the patient to extend through the base 311, 321 and cooperate with the tooth substitutes 330 to fill in the dentition. For example, such a dental arch may include one to fifteen tooth substitutes 330. In still other implementations, a partial denture may be configured to extend over only part of the upper arch or lower arch of the patient. In some implementations, a partial denture may include two to fifteen tooth substitutes mounted to a base that extends over only a portion of the upper or lower arch. For example, a partial denture arch may extend over only half of the upper arch or lower arch of the patient.

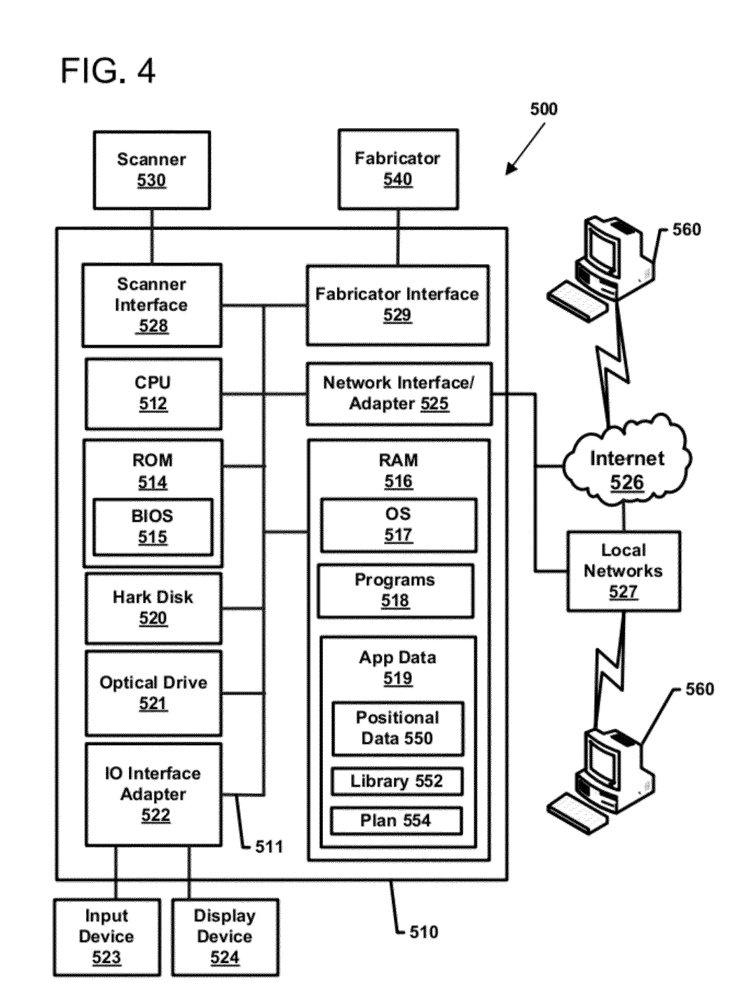

FIG. 4 illustrates an example design and production system 500 on which example processes of the present disclosure can be executed. In general, the system 500 includes a computing device 510 and a fabricator 540 coupled to the computing system 510. The computing device 510 is configured to implement at least a design portion of a denture manufacturing process by manipulating electronic models of dentures and/or denture components.

In some implementations, the computing device 510 also is configured to generate the electronic models. For example, the computing device 510 may be coupled to a scanner 530, remote computer 560, or other device that obtains or stores positional information from which electronic models may be generated. In other implementations, however, the computing device 510 is configured to obtain already generated electronic models from local memory or remote memory.

The computing device 510 also is configured to convert electronic models of the designed dentures or components thereof into a file format suitable for a fabricator 540. The fabricator 540 is configured to produce (e.g., print, mill, etc.) objects (e.g., prosthesis components, patterns of prosthesis components, dentition models, or portions thereof) based on the electronic models manipulated by the computing device 510.

One example of the computing device 510 includes a processor unit 512, read only memory (ROM) 514, random access memory (RAM) 516, and a system bus 511 that couples various system components including the RAM 516 to the processor unit 512. The system bus 511 may be any of several types of bus structures including a memory bus or memory controller, a peripheral bus and a local bus using any of a variety of bus architectures. A basic input/output system 515 (BIOS) is stored in ROM 514. The BIOS 515 contains basic routines that help transfer information between elements within the computing device 510. A number of software modules may be stored on the ROM 514, RAM 516, or other memory of the computing device 510. For example, the memory of the computing device 510 may include an operating system 517, one or more application programs (e.g., computer graphics programs) 518, and application data (e.g., electronic models, digitized positional data, etc.) 519.

Examples of other types of memory that may be included with the computing device 510 include a hard disk drive 520 for reading from and writing to a hard disk, a magnetic disk drive (not shown) for reading from or writing to a removable magnetic disk, and/or an optical disk drive 521 for reading from or writing to a removable optical disk such as a CD ROM, DVD, or other type of optical media. The hard disk drive 520, magnetic disk drive, and optical disk drive 521 can be connected to the system bus 511 by a hard disk drive interface (not shown), a magnetic disk drive interface (not shown), and an optical drive interface (not shown), respectively. The drives and their associated computer-readable media provide nonvolatile storage of computer readable instructions, data structures, programs, and other data for the computing device 510. Further examples of other types of computer-readable mediums that can be used in the example operating environment include magnetic cassettes, flash memory cards, digital video disks, and Bernoulli cartridges.

A user may enter commands and information into the computing device 510 through one or more input devices (e.g., a keyboard, a touch screen, and/or a mouse or other pointing device). Other examples of input devices 523 may include a microphone, a joystick, a game pad, a satellite dish, and a document scanner. In some implementations, these and other input devices may be connected to the processing unit 512 through an I/O port interface 522 that is coupled to the system bus 511. In other implementations, the input devices 523 also may be connected by other interfaces, such as a parallel port, game port, or a universal serial bus (USB). A monitor 524 or other type of display device also is connected to the system bus 511 via an interface, such as the IO interface 522. In addition to the monitor 524, computing systems typically include other peripheral output devices (not shown), such as speakers and document printers. The computing device 510 may operate in a networked environment using logical connections to one or more remote computers 560. In a networked environment, program modules depicted relative to the computing system 510, or portions thereof, may be stored in the remote memory storage device. Such networking environments are used in offices, enterprise-wide computer networks, intranets, and the Internet 526. For example, the computing device 510 may be connected to one or more remote computers 560 using a network interface 525. Each remote computer 560 may be a personal computer, a server, a router, a network PC, a peer device or other common network node, and typically includes many or all of the elements described above relative to the computing device 510.

In certain embodiments, the network connections can include a local area network (LAN) 527 or a wide area network (WAN). When used in a LAN networking environment, the computing system 510 is connected to the local network 527 through the network interface 525. When used in a WAN networking environment, the computing system 510 typically includes a modem, Ethernet card, or other such means for establishing communications over the wide area network, such as the Internet 526. The modem or other networking components, which may be internal or external, can be connected to the system bus 511 via the network interface 525 or an adapter. It will be appreciated that the network connections shown are exemplary and other means of establishing a communications link between the computers may be used.

In some embodiments, the fabricator 540 can be connected to the computing system 510 via an appropriate fabricator interface 529. In other implementations, the computing device 510 connects to the fabricator 540 over a network connection. The fabricator interface 529 can connected to the bus 511 such that the electronic model data may be retrieved from the appropriate location on the computing device 510 (or a remote computing device 560 connected thereto) and forwarded to the fabricator 540. In some implementations, the interface 529 converts the electronic models to a format readable by the fabricator 540. In one example implementation, the fabricator interface 529 converts the electronic model to an STL file. The converted file can be transmitted to the fabricator 540 using a direct line connection or using a networked connection described above.

In some implementations, the fabricator 540 includes a rapid prototyping machine configured to print wax patterns. Examples of such a rapid prototyping machines include the ProJet™ series of wax printers from 3D Systems of South Carolina. In other implementations, the fabricator device 540 may be a CNC milling machine. In other implementations, the fabricator device 540 may be a stereolithography machine. However, any type of fabricator 540 may be used without deviating from the spirit and scope of the disclosure.

In certain implementations, the design and production system 500 also includes a scanner 530 or other device configured to obtain positional data that can be used to generate electronic models. For example, a scanner 530 may be connected to the computing device 510 via an appropriate scanner interface 528. In other implementations, the computing device 510 connects to the scanner 530 over a network connection. The scanner 530 is connected to the bus 511 such that the positional data may be stored in the appropriate memory location, manipulated by the CPU 512, displayed on the display device 524, etc.

In some implementations, the scanner 530 is an intra-oral scanner configured to digitize anatomy within a patient's mouth to obtain positional information of the anatomy. In other implementations, the scanner 530 is a three-dimensional scanner that is configured to scan physical models of anatomical structures to be digitized. Some non-limiting examples of suitable scanners include a laser line scanner, a CT scanner, an MRI scanner, and a confocal scanner. However, any suitable scanner 530 may be used. In still other implementations, a number of other methodologies might be employed to digitize patient anatomy or prosthetic components.

Portions of the disclosure constructed in accordance with the principles of the present invention utilize a computing device and are described herein as implemented by logical operations performed by the computing device. As noted, the logical operations of these various computer implemented processes are generally performed either (1) as a sequence of computer implemented steps or program modules running on the computing device and/or (2) as interconnected machine modules or hardware logic within the computing system. The implementation is a matter of choice dependent on the performance requirements of the computing system implementing the invention. Accordingly, the logical operations making up the implementations of the disclosure described herein can be variously referred to as operations, steps, or modules.

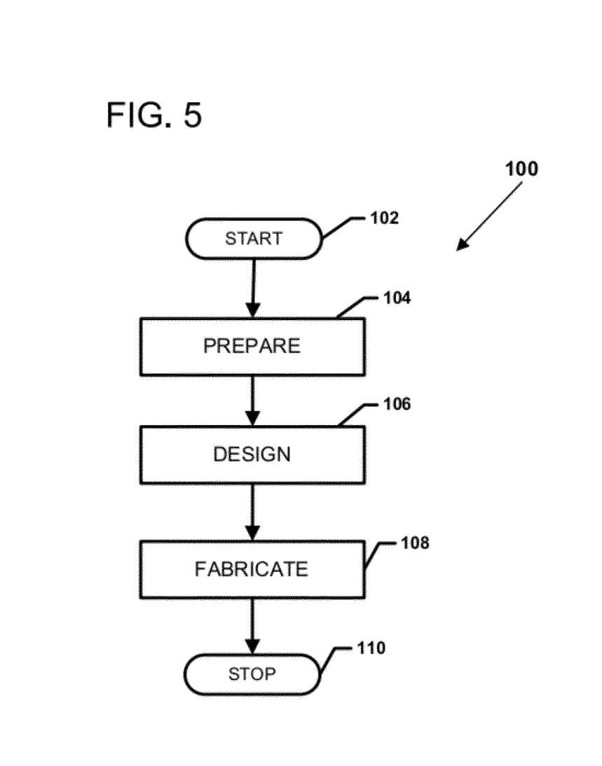

FIG. 5 is a flowchart illustrating a flow for an example denture design process 100 that can be used to design one or more denture arches for a patient. In accordance with certain aspects, the design process 100 may be implemented on the design and manufacturing system 500 shown in FIG. 4. In accordance with some aspects, the design process 100 can be used to design full denture arches. In accordance with other aspects, the design process 100 can be used to design one or more partial denture arches for the upper dentition and/or the lower dentition. The design process 100 performs any appropriate initialization procedures, begins at a start module 102, and proceeds to a prepare operation 104.

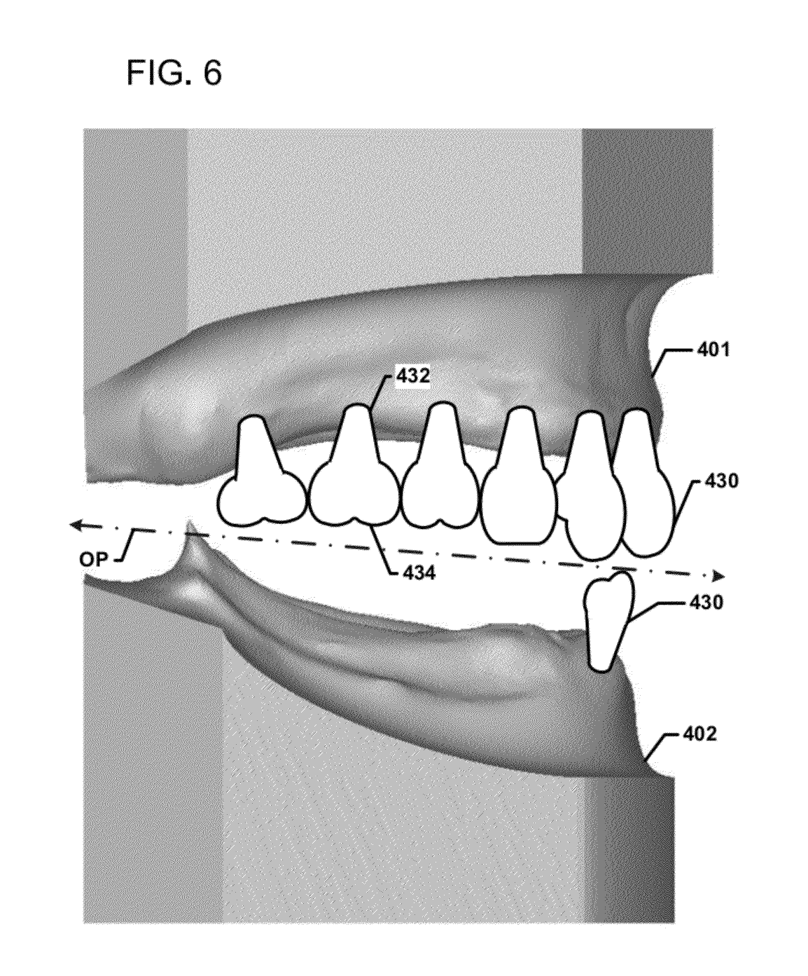

The prepare operation 104 creates a dentition plan for how the tooth substitutes 330 should be arranged (e.g., positioned, oriented, and sized) in the patient's mouth. The prepare operation 104 creates the dentition plan using electronic models 401, 402 of the patient's upper and lower arches, respectively, and electronic models 430 of tooth substitutes 330 (see FIG. 6). More details of one example process by which the prepare operation 104 may be implemented are supplied herein with reference to FIGS. 6-12. In some implementations, the prepare operation 104 is implemented using a computer graphics program stored on a computing device (see programs 518 stored in computing device 510 of FIG. 4). In other implementations, other types of computer programs may be used to form the dentition plan.

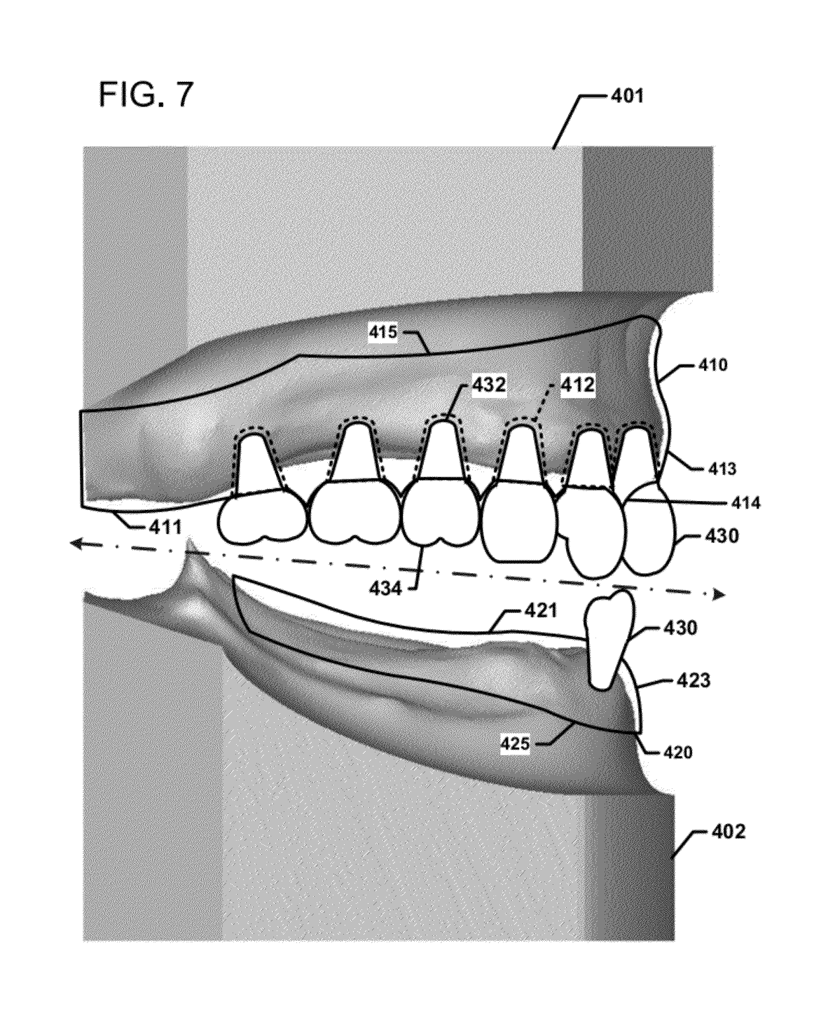

A design operation 106 generates an electronic model 410, 420 of a denture base 311, 321, respectively, to accommodate the root portions 432 of the tooth substitute models 430 (see FIG. 7). In certain implementations, the design operation 106 generates a first denture base model 410 for the upper jaw and a second denture base model 420 for the lower jaw. The design operation 106 uses edentulous jaw models 401, 402 of the patient and the dentition plan prepared in operation 104 to design each denture base model 410, 420. The design operation 106 forms an attachment section 415, 425 of the denture base model 410, 420 to enable the fabricated denture base 311, 321 to be secured in the mouth of the patient.

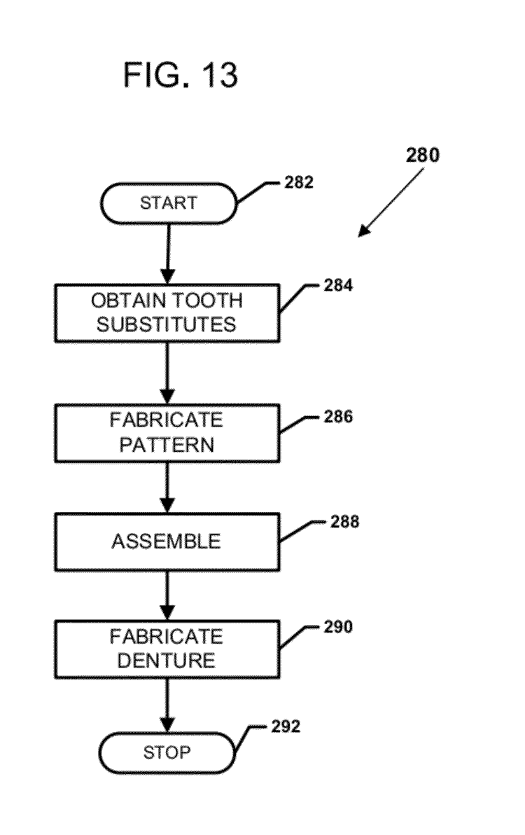

A fabricate operation 108 produces the denture arches 310, 320 based at least in part on the denture base models 410, 420. One example manufacturing process 280 by which the dentures 310, 320 may be produced is shown in FIG. 13. In accordance with some aspects, the fabrication operation 108 is implemented using the design and manufacturing system 500 shown in FIG. 4. In accordance with other aspects, the fabrication operation 108 includes sending the denture arch models 401, 402 to a third party manufacturer for fabrication.

The denture design process 100 performs any appropriate completion procedures and ends at a stop module 110. The fabricated dentures may be provided to the patient or to a dentist for insertion in the mouth of the patient.

Of course, the above steps need not be performed completely in the order listed. In some implementations, a user may modify the placement of one or more tooth substitute models 430 in the dentition plan to better accommodate a denture base model 410, 420. For example, a user may need to adjust an angle at which a root 432 of a tooth substitute extends into (and emerges from) the base model 410 to accommodate a necessary socket size for holding the root. Adjustments may be made for structural and/or cosmetic reasons.

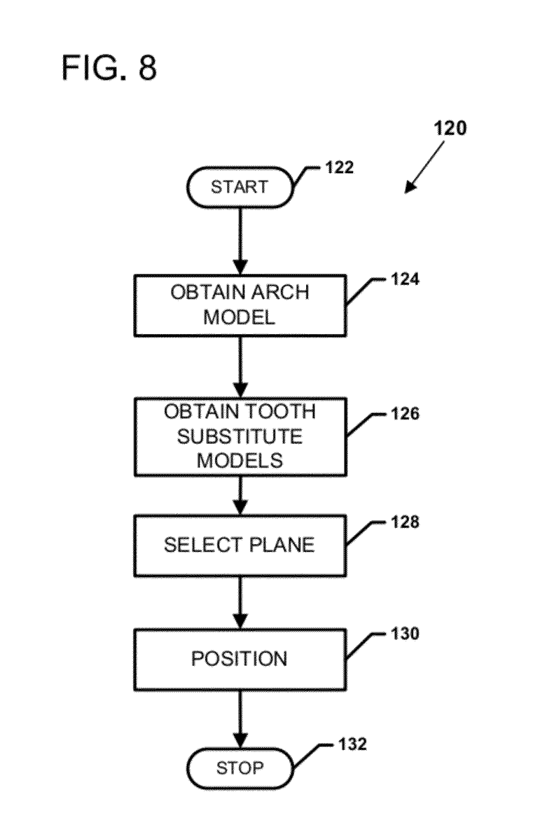

FIG. 8 is a flowchart illustrating a flow for an example preparation process 120 by which the prepare operation 104 of FIG. 5 may be implemented. The preparation process 120 performs any appropriate initialization procedures, begins at a start module 122, and proceeds to a first obtain operation 124.

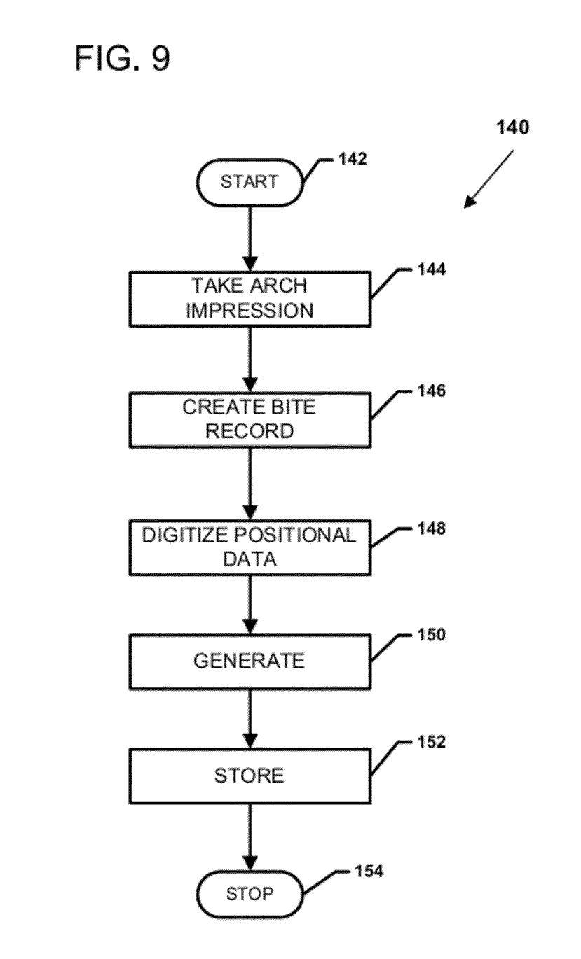

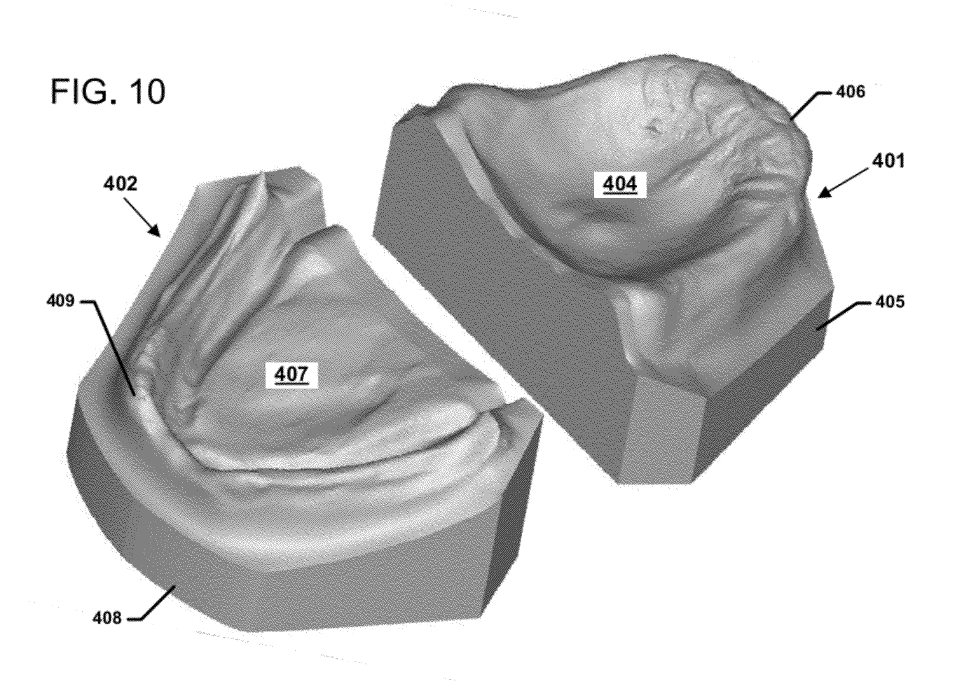

At the first obtain operation 124, a user obtains one or more electronic models 401, 402 representing the arches of the patient (e.g., the edentulous jaws, the partially edentulous jaws, etc.) of the patient (see FIGS. 9 and 10). In some implementations, the first obtain operation 124 includes retrieving the electronic models 401, 402 from an electronic memory (e.g., local memory, remote memory etc.). For example, in certain implementations, the first obtain operation 124 retrieves the electronic models 401, 402 from the application data 519 stored in the RAM 516 of the computing device 510.

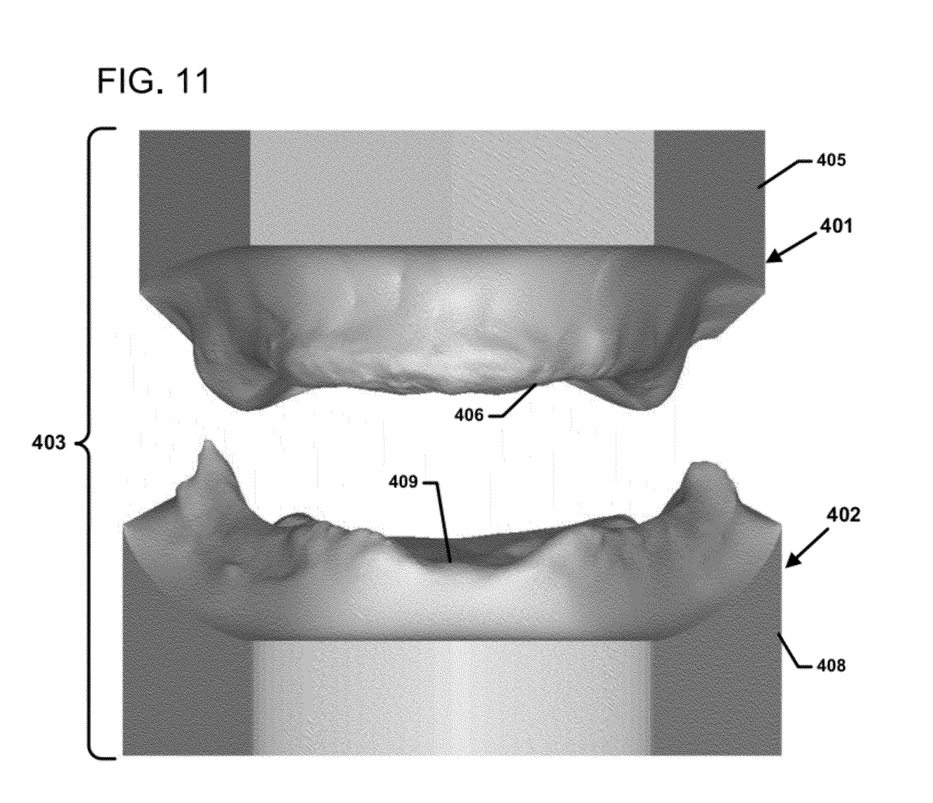

In other implementations, the first obtain operation 124 includes acquiring positional data representing the dental arches and generating the electronic models 401, 402 based on the acquired positional data. For example, in various implementations, the first obtain operation 124 may obtain positional data from electronic memory, from an intra-oral scan of the actual dental arches, from a scan of an impression, or from a scan of a replicate physical model. One example process for generating the electronic models 401, 402 from positional data is disclosed in U.S. Published Application No. 2004-0017369, filed Jan. 22, 2003, and entitled “Method and Apparatus for Computer Generation of Electronic Model Images,” now abandoned, the disclosure of which is hereby incorporated by reference herein. In still other implementations, the first obtain operation 124 includes obtaining the positional data, e.g., as disclosed below with respect to FIG. 11.

In one implementation, the user obtains a single electronic model representing the upper and lower jaws positioned relative to each other in accordance with an actual bite of the patient (e.g., a centric occlusion bite, a centric relation bite, etc.). In another implementation, the user obtains a first electronic model 401 representing the upper arch, a second electronic model 402 representing the lower arch, and relative positioning information representing an actual bite of the patient. In still other implementations, each arch can be represented by multiple electronic models with each model representing a portion of one of the arches.

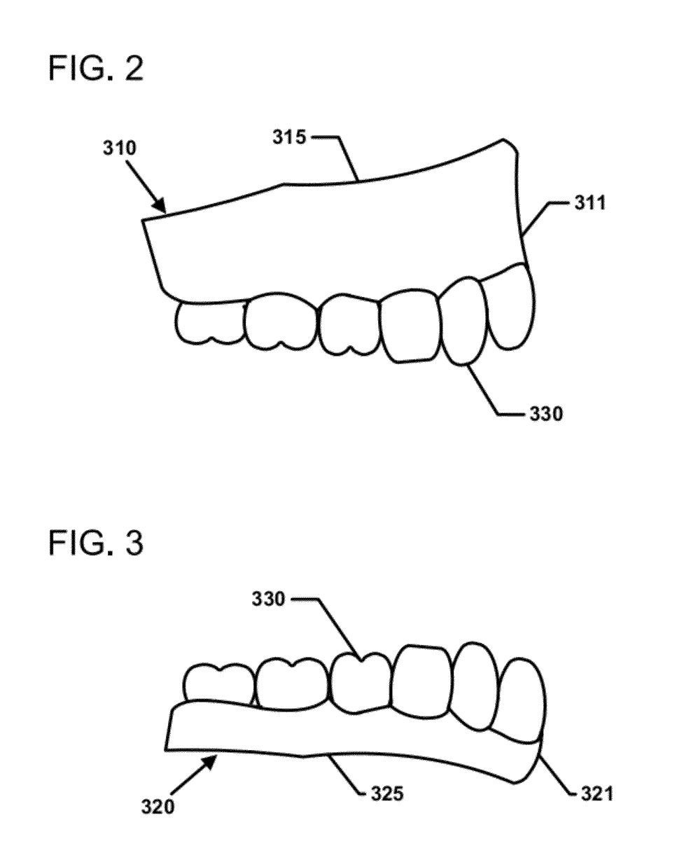

At a second obtain operation 126, the user obtains one or more electronic models 430 (e.g., see FIG. 6) of the tooth substitutes 330 that will be used in the manufactured dentures. In some implementations, the second obtain operation 126 includes retrieving the tooth substitute models 430 from electronic memory (e.g., application data 519 of FIG. 2, memory of a remote computer 560, etc.). In other implementations, the second obtain operation 126 includes generating the electronic models 430 from positional data stored in electronic memory (e.g., application data 519 of FIG. 4, memory of a remote computer 560, etc.). In still other implementations, the second obtain operation 126 includes acquiring the positional data (e.g., via a scanner) and generating the electronic models 430 (e.g., using a model generation program stored on the computing device 510 or remotely).

In some implementations, the tooth substitute electronic models 430 are created from the actual tooth substitutes 330 (e.g., by scanning or otherwise digitizing positional data of the physical tooth substitutes 330). In other implementations, the second obtain operation 126 includes accessing a library of generic electronic models 430 of teeth and selecting the electronic models 430 of the appropriate teeth. In various examples, the library may be stored in RAM 516, on hard disk 520, on optical disk 521, or remotely from the computing device 510 in FIG. 4). In still other implementations, the second obtain operation 126 can include generating models 430 of tooth substitutes 330 customized for each patient. For example, in some implementations, the tooth substitutes 330 can be fabricated based on electronic models 401, 402 of the patient's arches (e.g., an electronic model of a partially edentulous arch, an electronic model of the arch prior to tooth loss, the electronic model obtained in operation 124, etc.).

A select operation 128 displays the dental arch electronic models 401, 402 to the user and enables the user to define an occlusal plane along which the teeth of the upper dental arch should interact with the teeth of the lower dental arch (e.g., see FIG. 6). In accordance with some aspects, the user determines the location of the occlusal plane OP based on one or more electronic images of the patient's dental arches. In some implementations, the user defines the occlusal plane OP by viewing a Cephalometric X-ray or other 2D image. In other implementations, the user defines the occlusal plane OP by viewing a Cone Beam scan or other 3D image. In still other implementations, the user defines the occlusal plane OP using a digitized or manual face bow.

A position operation 130 places the tooth substitute models 430 relative to the arch models 401, 402 (see FIG. 6). For example, in the position operation 130, the user superimposes the tooth substitute electronic models 430 over the electronic models 401, 402 representing the edentulous or partially edentulous arches. The tooth substitute electronic models 430 may be manipulated (e.g., translated, rotated, sized, etc.) into a desired position relative to the edentulous arches 401, 402 to form a patient dentition. In certain implementations, the tooth substitute models 430 are positioned so that the crown portions 434 of the models 430 generally align with the occlusal plane OP defined in the select operation 128.

The preparation process 120 performs any appropriate completion procedures and ends at a stop module 132.

FIG. 9 is a flowchart illustrating an operational flow for an example digitizing process 140 by which an electronic model 401, 402 of an edentulous arch (see FIGS. 10-11) may be obtained. For example, the digitizing process 140 can be used to implement the first obtain operation 124 of the preparation process 120 of FIG. 8. The digitizing process 140 performs any appropriate initialization procedures, begins at a start module 142, and proceeds to an obtain operation 144.

At the obtain operation 144, a dentist or technician takes an impression of at least part of the gingival surface of a dental arch of a patient. In certain implementations, the obtain operation 144 includes taking an impression of the gingival surface of the upper and lower arches of the patient. For example, in some implementations, the obtain operation 144 includes filling a tray with impression material, placing the tray and material in the patient's mouth, and instructing the patient to bite down into the impression material until the material has hardened sufficiently to hold the form of the gingival surface of the jaw. In other implementations, a physical model of the patient's jaw is otherwise obtained.

A second obtain operation 146 includes forming a record of the relative positions of the upper and lower edentulous arches of the patient in at least a first bite position. For example, in one implementation, the second obtain operation 146 may include forming a record of a centric relation bite of the patient. In another implementation, the second obtain operation 146 may include forming a record of a centric occlusion bite of the patient. In certain implementations, the second obtain operation 146 includes placing a strip of wax between the edentulous gums of the patient and instructing the patient to bite down in the desired bite position. In other implementations, the second obtain operation 146 includes scanning the edentulous gums of the patient while the patient is biting down in the desired position.

A scan operation 148 digitizes the positional data acquired in the first and second obtain operations 144, 146. For example, in some implementations, the scan operation 148 includes scanning the arch impressions acquired in the first obtain operation 144. In one implementation, the scan operation 148 acquires positional data from the negative impression of the edentulous arch with a CT scanner or MRI scanner. In other implementations, other scanning equipment may be utilized. One example scanning process that can be used to implement the scan operation 148 is found in U.S. Pat. No. 6,217,334, filed Jan. 28, 1997, titled “Dental Scanning Method and Apparatus,” the disclosure of which is hereby incorporated by reference herein.

A generate operation 150 creates the electronic models 401, 402 of the edentulous or partially edentulous arches based on the digitized positional information. In one implementation, the generate operation 150 creates an electronic models 401, 402 of a positive representation of the arches based on the digitized negative impressions. In another implementation, the generate operation 150 creates an electronic model 401, 402 of the arches based on the digitized casting of the dentition. One example for a model generation process suitable for use with the generate operation 150 is disclosed in more detail in U.S. Pat. No. 6,217,334, which was incorporated by reference above.

In certain implementations, a store operation 152 may store the positional information in memory (e.g., see positional data 550 in RAM 516 of FIG. 4). For example, in some implementations, the generated electronic models 401, 402 may be stored in local memory and/or transferred over a data network to a remote computing device (e.g., remote device 560) for storage. In other implementations, the raw positional data (e.g., a point cloud) may be stored.

The digitizing process 140 performs any appropriate completion procedures and ends at a stop module 154.

In other implementations, electronic models of the arches 401, 402 may be obtained by otherwise collecting positional data representing the edentulous arches. For example, in certain implementations, the positional data may be directly obtained using an intra-oral scanner. In other implementations, the positional data may be obtained from a representation of the dentition (e.g., a casting formed with the impression). In one implementation, the positional data may be obtained by a CT scanner. In another implementation, the positional data may be obtained by an MRI scanner. In another implementation, the positional data may be obtained by a laser line scanner. In still other implementations, the electronic model of the edentulous arch may be obtained by starting with an electronic model of a generic edentulous jaw and modifying the electronic model based on a CT scan, MRI scan, X-ray, Cephalograph, or other image showing the patient's jaw.

FIGS. 10 and 11 illustrate example electronic models 401, 402 of edentulous upper and lower arches, respectively. In some implementations, the electronic models 401, 402 are fixed relative to each other to form a composite electronic model 403 (see FIG. 11). In other implementations, the upper and lower arches are each represented by a single electronic model 401, 402.

The upper arch model 401 represents the gingival surface 406 of the maxillary arch of a patient. In some implementations, the maxillary arch model 401 also represents other anatomy of the maxilla, such as the soft palette 404 of the patient (FIG. 10). In certain implementations, the maxillary model 401 includes a base 405 from which the gingival surface 406 extends. In one implementation, the design for the base 405 is taken from a scanning base or tool plate on which a physical model of the maxillary arch is mounted to a scanner 530. In other implementations, the base 405 is generated to indicate an appropriate orientation to the technician (e.g., to provide a plane parallel or perpendicular to anatomical landmarks (e.g., the midline of the patient, teeth or portions thereof, etc.).

The lower arch model 402 represents the gingival surface 409 of the mandibular arch of the patient. In some implementations, the mandibular model 402 also represents other anatomy of the mandible, such as the tongue 407 of the patient. In certain implementations, the mandible model 402 includes a base 408 from which the gingival surface 409 extends. In one implementation, the design for the base 408 is taken from a scanning base or tool plate on which a physical model of the mandibular arch is mounted to the scanner 530. In other implementations, the base 408 is generated to indicate an appropriate orientation to the technician (e.g., to provide a plane parallel or perpendicular to the anatomical landmarks).

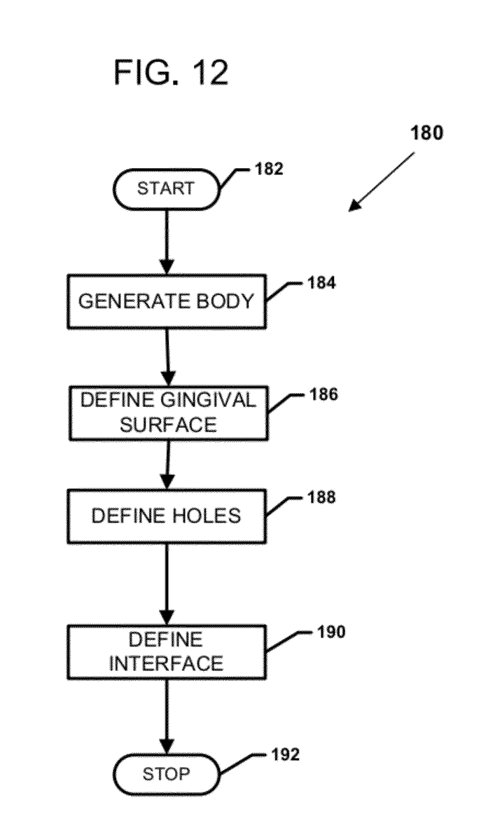

FIG. 12 is a flowchart illustrating an operational flow for an example denture base design process 180 by which an electronic model 410, 420 of a denture base 311, 321 (see FIG. 7) may be obtained. For example, the denture base design process 180 can be used to implement the design operation 106 of the design process 100 of FIG. 5. The denture base design process 180 performs any appropriate initialization procedures, begins at a start module 182, and proceeds to a generate operation 184.

The generate operation 184 creates an electronic model 410, 420 of the denture base 311, 321 that accommodates the arrangement of the tooth substitutes of the dentition plan. For example, the design operation 106 may generate a first denture base model 410 using arch model 401 and the dentition plan prepared in operation 104 of design process 100 of FIG. 5. The design operation 106 may generate a second denture base model 420 using arch model 402 and the dentition plan prepared in operation 104 of design process 100 of FIG. 5. In some implementations, the labial portion of the base model 410, 420 has a vertical height that is sized to cover a majority (e.g., greater than 50%) of the labial side of the actual gingival surface of the patient. In other implementations, the vertical height of the labial side of the base model 410, 420 is sized to cover only part (e.g., 50% or less) of the labial side of the gingival surface.

In some implementations, the generate operation 184 may superimpose a generic base model over the dental arch model 401, 402 and enable a user to modify (e.g., size, deform, translate, rotate, etc.) the generic base model to fit the dental arch model 401, 402. In other implementations, the generate operation 184 may generate a customized base model 410, 420 based on landmark positional data acquired from the dental arch model 401, 402. Of course, the generate operation 184 also may enable user modification of the customized base model 410, 420.

A first define operation 186 forms a gingival surface 413, 423 of the base model 410, 420. The first define operation 186 designs the gingival surface 413, 423 of each denture base model 410, 420 to approximate the actual gingival surface of the patient. The gingival surface 413, 423 of the base model 410, 420 is designed to accommodate the emergence profile of the crown portion 434 of the tooth substitute models 430. In certain implementations, portions of the gingival surface 413, 423 are configured to extend partially between the clinical crowns of the tooth substitutes 430 (see gingival portions 414 of FIG. 7).

A second define operation 188 provides a plurality of sockets extending through the gingival surface 413, 423 of the generated denture base model 410, 420 (e.g., see sockets 412 of FIG. 7). The second define operation 188 produces sockets that are sized and shaped to accommodate the roots 432 of the tooth substitutes models 430 arranged according to the dentition plan. For example, the sockets may be sized, shaped, and oriented to accommodate the angle and depth at which the roots 432 of the tooth substitute models 430 extend through the base model 410, 420.

A third define operation 190 forms the gingival interface 415, 425 portion of the base model 410, 420 to enable a fabricated denture base 311, 321 to be secured in the mouth of the patient. In some implementations, the attachment section 415, 425 includes a contoured surface that is shaped and sized to seat on the gingival surface of the patient. In one implementation, the attachment section 415, 425 provides space for a dental adhesive to be utilized to hold a fabricated denture base 311, 321 to the gingival surface. In other implementations, the attachment section 415, 425 is configured to suction fit or friction fit to the gingival surface of the patient.

The denture base design process 180 performs any appropriate completion procedures and ends at a stop module 192.

Of course, the above recited steps need not be performed in the order listed. A user may interactively modify any portion of the dental base model 410, 420 in any desired order. For example, a user may define the sockets for the tooth substitutes before completely designing the gingival surface. The gingival interface of the base model 410, 420 may be defined before the visible surface.

FIG. 13 is a flowchart illustrating a flow for an example manufacturing process 280 that can be used to manufacture a denture arch 310, 320 for a patient. For example, the manufacturing process 280 may be used to fabricate one or more denture arches 310, 320 based on denture arch models 401, 402 created in the design process 100 of FIG. 5. In accordance with certain aspects, the manufacturing process 280 may be implemented on the design and manufacturing system 500 shown in FIG. 4. The manufacturing process 280 performs any appropriate initialization procedures, begins at a start module 282, and proceeds to an obtain operation 284.

An obtain operation 284 obtains the tooth substitutes 330 to be used in the denture arch or arches 310, 320 being produced. In some implementations, the obtain operation 284 acquires generic tooth substitutes 330 (e.g., from a third party manufacturer). In certain implementations, the obtain operation 284 modifies the generic tooth substitutes 330 to fit in the patient's mouth. In other implementations, the obtain operation 284 fabricates (e.g., prints, casts, or mills) the tooth substitutes 330 from the electronic models 430 of the tooth substitutes. In some implementations, the obtain operation 284 may fabricate the tooth substitutes 330 if the electronic models 430 were customized to the patient. For example, the tooth substitute models 430 may be have generated based on any remaining teeth the patient has, other dental landmarks in the mouth of the patient, or positional data of patient teeth previously obtained from the patient. In certain implementations, the obtain operation 284 also modifies the customized tooth substitutes 330 to better fit in the patient's mouth.

A first fabricate operation 286 produces a pattern of the denture base 311, 321 based on the denture base model 410, 420 generated in design operation 106. The pattern of each denture base 311, 321 defines openings configured to receive the roots 332 of the tooth substitutes 330. In some implementations, the first fabricate operation 286 includes printing a pattern of the denture base 311, 321. In other implementations, the first fabricate operation 286 includes milling a pattern of the denture base 311, 321.

An assemble operation 288 positions the teeth substitutes in the pattern of each denture base 311, 321 to form one or more fabrication assemblies. For example, a dental technician may position tooth substitutes 330 of anterior teeth in openings at the front of the pattern and tooth substitutes 330 of molars in openings at the rear of the pattern. In certain implementations, the tooth substitutes 330 may be secured to the pattern with wax or another sealer to form the fabrication assemblies. For example, a technician may apply wax over the seam between the tooth substitutes 330 and the pattern.

A second fabricate operation 290 produces denture arches 310, 320 based on the fabrication assemblies. The denture arches include one or more denture bases 311, 321 holding the tooth substitutes 330 in accordance with the dentition plan. In some implementations, the denture bases 311, 321 may be cast using a lost wax casting technique as will be described in more detail herein. In other implementations, the denture bases 311, 321 may be milled.

The manufacturing process 280 performs any appropriate completion procedures and ends at a stop module 292.

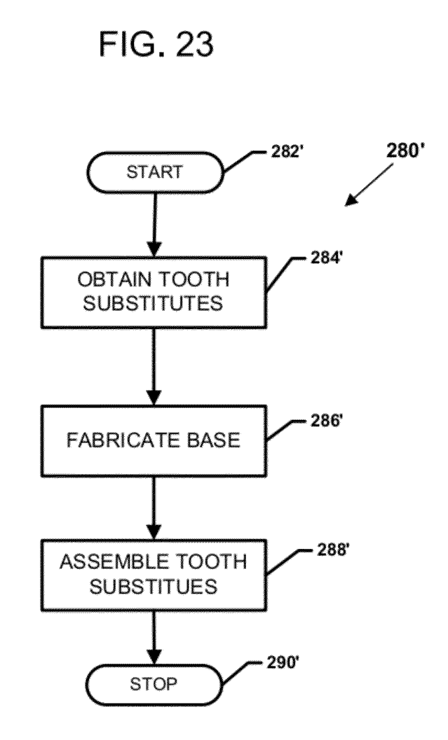

FIG. 23 is a flowchart illustrating a flow for another example manufacturing process 280′ that can be used to manufacture a denture arch 310, 320 for a patient. For example, the alternative manufacturing process 280′ may be used to fabricate one or more denture arches 310, 320 based on denture arch models 401, 402 created in the design process 100 of FIG. 5. In accordance with certain aspects, the alternative manufacturing process 280′ may be implemented on the design and manufacturing system 500 shown in FIG. 4. The alternative manufacturing process 280′ performs any appropriate initialization procedures, begins at a start module 282′, and proceeds to an obtain operation 284′.

The obtain operation 284′ obtains the tooth substitutes 330 to be used in the denture arch or arches 310, 320 being produced. In some implementations, the obtain operation 284′ acquires generic tooth substitutes 330 (e.g., from a third party manufacturer). In certain implementations, the obtain operation 284′ modifies the generic tooth substitutes 330 to fit in the patient's mouth. In other implementations, the obtain operation 284′ fabricates (e.g., prints, casts, or mills) the tooth substitutes 330 from the electronic models 430 of the tooth substitutes. In some implementations, the obtain operation 284′ may fabricate the tooth substitutes 330 if the electronic models 430 were customized to the patient. For example, the tooth substitute models 430 may be have generated based on any remaining teeth the patient has, other dental landmarks in the mouth of the patient, or positional data of patient teeth previously obtained from the patient. In certain implementations, the obtain operation 284′ also modifies the customized tooth substitutes 330 to better fit in the patient's mouth.

A fabricate operation 286′ produces the denture base 311, 321 based on the denture base model 410, 420 generated in design operation 106 of design process 100. For example, in some implementations, the fabricate operation 286′ mills the denture base 311, 321 using a CNC-milling machine. In other implementations, the fabricate operation 286′ prints the denture base 311, 321 from a biocompatible material. Each denture base 311, 321 defines openings configured to receive the roots 332 of the tooth substitutes 330.

An assemble operation 288′ positions the tooth substitutes 330 in each denture base 311, 321 to form one or more denture arches 310, 320. For example, a dental technician may position tooth substitutes 330 of anterior teeth in openings at the front of the bases 311, 321 and tooth substitutes 330 of molars in openings at the rear of the bases 311, 321. In certain implementations, the tooth substitutes 330 may be secured to the bases 311, 321 with dental adhesive or other bonding agent. In other implementations, the tooth substitutes may be fastened to the bases 311, 321 (e.g., using screws, bolts, etc.).

The alternative manufacturing process 280′ performs any appropriate completion procedures and ends at a stop module 290′.

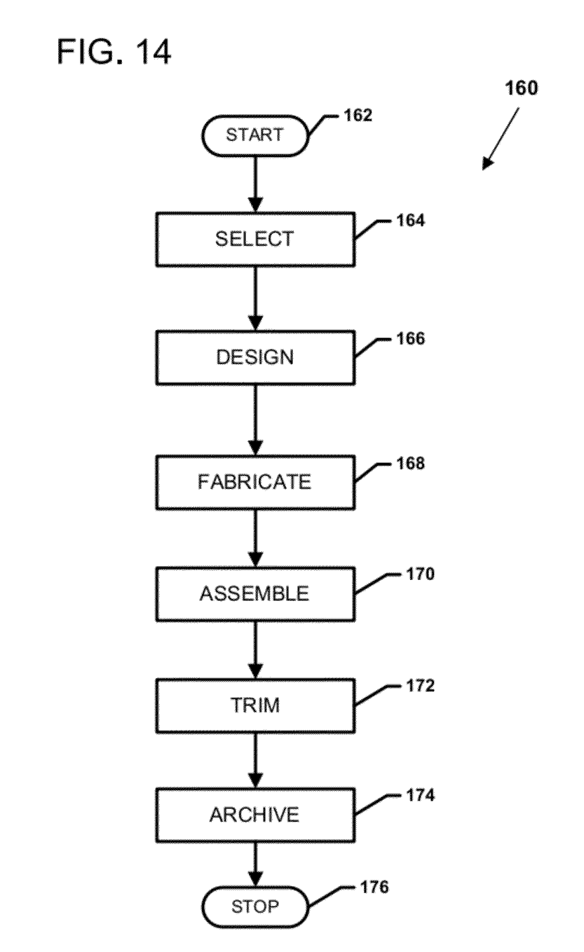

FIG. 14 is a flowchart illustrating a flow for an example modification process 160 that can be used to modify the root portion 332 a tooth substitute 330 to fit in the denture base 311, 321. For example, the modification process 160 may be used in implementing the obtain operation 284 of manufacturing process 280. In accordance with certain aspects, the modification process 160 may be implemented on the design and manufacturing system 500 shown in FIG. 4. The modification process 160 performs any appropriate initialization procedures, begins at a start module 162, and proceeds to a select operation 164.

The select operation 164 determines whether to trim the roots 432 of the tooth substitute models 430 to fit the denture base models 410, 420. For example, as shown in FIG. 15, the roots 432 of the tooth substitute models 430 may include excess material that need to be removed to enable the roots 432 to properly fit in the sockets 412 of the denture base model 410. The select operation 164 determines the cutoff location for the roots 432. In some implementations, the select operation 164 determines one or more planes or cutting surfaces along which the roots 432 should be cut. In the example shown in FIG. 15, the select operation 164 defines a continuous tool path TP along the cutting surfaces. In other implementations, however, a separate tool path TP may be computed for each cutting surface.

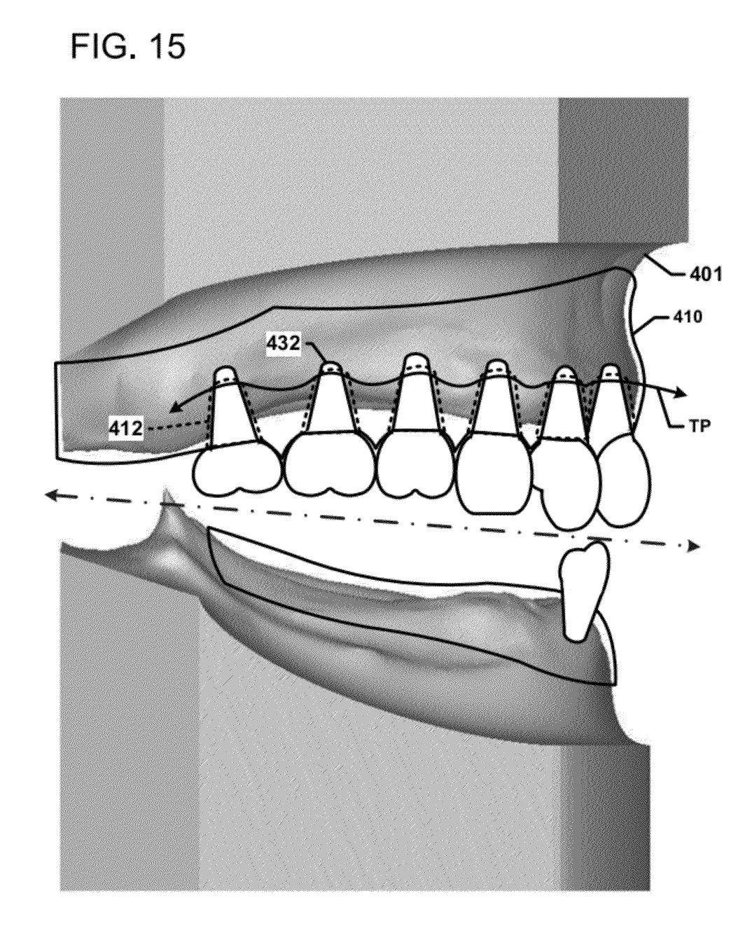

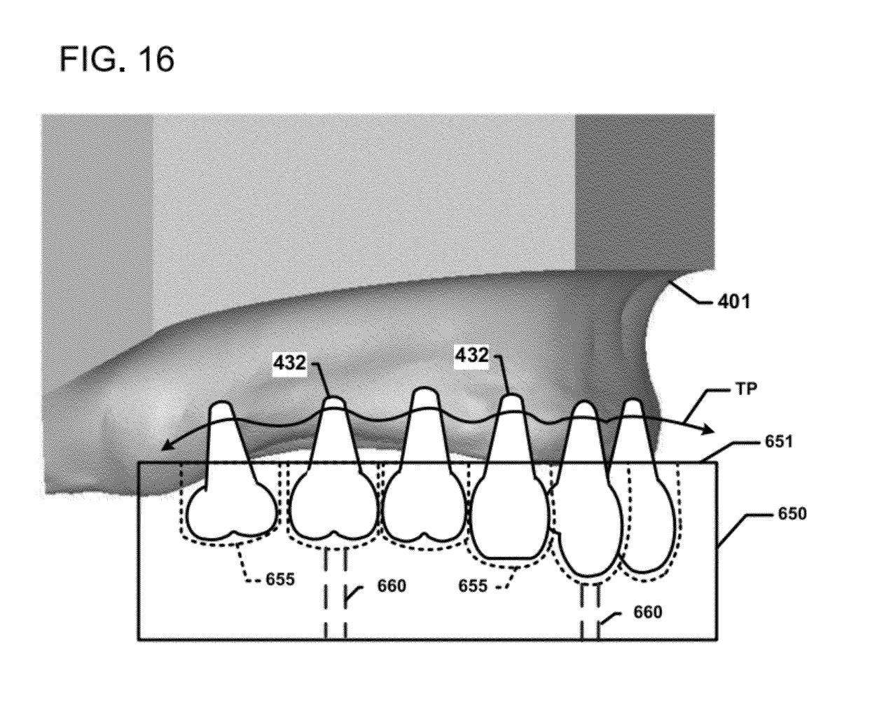

A design operation 166 generates an electronic model 650 of a jig 600 for use in modifying the roots 332 of the physical tooth substitutes 330 using the computed tool path(s) TP (e.g., see FIG. 16). The jig 600 will hold the tooth substitutes 330 as the roots 332 are trimmed (e.g., using a CNC milling machine). The design operation 166 creates the electronic model 650 with a top surface 651 defining a plurality of holes 655. Each hole 655 is sized and shaped to accommodate the crown 434 of one of the tooth substitute models 430. In some implementations, the design operation 166 also creates channels 660 leading from the holes 655 to an exterior of the jig 600. In certain implementations, the channels 660 are sized to enable a vacuum to be drawn in each hole 655. In other implementations, the channels 660 are sized to enable an ejector to extend into each hole 660.

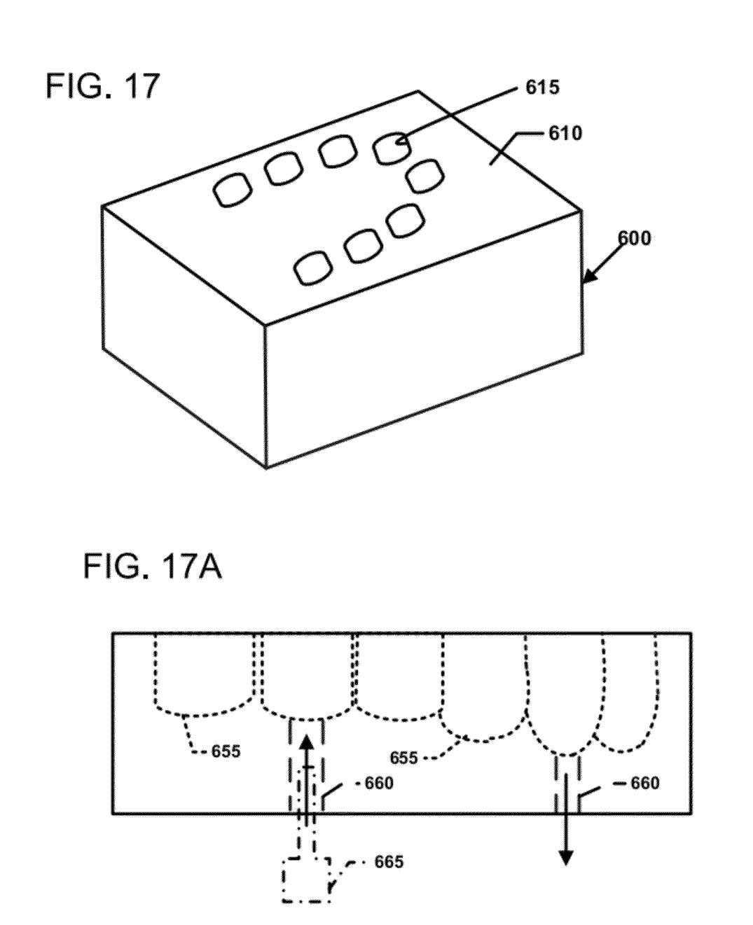

A fabricate operation 168 produces the jig 600 based on the electronic model 650. The physical jig 600 includes a top surface 610 defining a plurality of sockets 615 configured to accommodate the crowns 334 of a plurality of tooth substitutes 330. In general, the sockets 615 are arranged so that the roots 332 of the tooth substitutes 330 protrude at a known angle and length from the jig surface 610. In some implementations, the sockets 615 are arranged so as to position the tooth substitutes 330 in accordance with the dentition plan (see FIG. 17). In other implementations, the sockets 615 may be arranged in any desired configuration (e.g., columns and rows, rings, etc.).

An assemble operation 170 positions the tooth substitutes 330 to be trimmed in the fabricated jig 600 (see FIG. 18). For example, the assemble operation 170 places the crown 334 of each tooth substitute 330 in the corresponding socket 615 of the jig 600. In some implementations, the tooth substitutes 330 may be held within the sockets 615 by drawing a vacuum through one or more vacuum tubes 660 defined in the jig 600 (FIG. 17A). In other implementations, the tooth substitutes 330 may be held within the sockets 615 using a temporary bonding agent (i.e., adhesive).

A trim operation 172 removes the excess material from the roots 332 of the tooth substitutes 330. For example, in some implementations, the trim operation 172 uses a computer controlled milling machine to remove the excess material from the roots 332 along the tooth path TP. The tooth substitutes 330 are held in position within the jig 600 (e.g., using a vacuum, using adhesive, etc.). In other implementations, a technician may manually remove the excess material from the roots 332 of the tooth substitutes 330.

An optional archive operation 174 stores the design for the jig 600 and/or stores the tooth path TP. For example, the archive operation 174 may store the information in local memory, remote memory, or on a portable computer readable medium (e.g., CD, disk, memory stick, etc.). In some implementations, the trimmed tooth substitutes 330 are being used in a temporary denture arch that is used by the patient while the patient is healing from oral surgery. In some such implementations, the archived design for the jig 600 and archived tooth path TP may be used when producing tooth substitutes 330 for the permanent denture arch.

The modification process 160 performs any appropriate completion procedures and ends at a stop module 176. For example, the tooth substitutes 330 may be removed from the jig 600. For example, a suction force may be released; a temporary bonding agent may be dissolved, and/or one or more ejector pins 665 (FIG. 17A) may be inserted through the channels 660 to push the tooth substitutes 330 out of the sockets 615. In addition, the above recited steps need not be performed completely in the order listed. For example, a user may switch between selecting the cutting surfaces for the roots and designing the jig.

As noted above, temporary denture arches 310, 320 may be produced for the patient to wear while recovering from oral surgery. In such implementations, the gingival surface of the patient is likely swollen or otherwise deformed. As the patient heals, the gingival surface may change shape sufficient to inhibit a proper fit with the gingival interface of the denture arch 310, 320.

In some implementations, the above described process is repeated to produce a permanent set of dentures for the patient. For example, new positional information for the patient's dental arches is obtained and new dentures are designed to fit the healed gingival surface. In some such cases, the previously prepared dentition plan may be reused or modified to create a new dentition plan to fit the healed dental arches. In certain implementations, the previously prepared jigs and tooling paths also may be reused or modified.

In other implementations, the temporary denture arches 310, 320, themselves, may be modified to produce the permanent denture arches. FIG. 19 is a flowchart illustrating a flow for an example adjustment process 250 that can be used to modify the gingival interface portion 315, 325 (FIGS. 2 and 3) of the denture bases 311, 321 to fit the healed gingival surface of the patient. In accordance with certain aspects, the adjustment process 250 may be implemented on the design and manufacturing system 500 shown in FIG. 4. FIGS. 20-22 illustrate steps of the adjustment process 250 as performed to an example mandibular dental arch 320.

The adjustment process 250 performs any appropriate initialization procedures, begins at a start module 252, and proceeds to an obtain operation 254. The obtain operation 254 acquires the physical temporary denture arches 310, 320 of the patient. For example, FIG. 20 is a rear, schematic view of an example mandibular denture arch 320 holding tooth substitutes 330. Portions of the gingival interface 325 of the denture arch 320 are visible in FIG. 20.

A fill operation 256 adds material 327 to the gingival interface 325 (see FIG. 21). In general, the added material 327 is suitable for use inside a patient's mouth, such as a denture acrylic. In some implementations, the fill operation 256 adds the material 327 to form a relatively flat surface. In other implementations, the fill operation 256 may form a surface having any desired contours. In some implementations, the fill operation 256 is performed manually by a technician. In other implementations, the fill operation 256 is performed automatically using a printer or other type of deposition machine.

A design operation 258 determines the contours for a new gingival interface 325′. In some implementations, the design operation 258 determines the contours based on the healed gingival surface of the patient. For example, the design operation 258 may include obtaining an electronic model or positional information for the healed dental arch of the patient. The design operation 258 also may superposition an electronic model of the denture base including the filling material over the electronic model of the healed gingival surface. In some implementations, the design operation 258 enables a user to interactively modify the electronic model of the denture base to form an appropriate gingival interface. In other implementations, the design operation 258 automatically produces a gingival interface based on the positional information of the healed gingival surface.

A construct operation 260 forms the new gingival interface 325′ in the denture arch 320 (see FIG. 21). In some implementations, the construct operation 260 mills the new gingival interface 325′ from the added material 327 of the denture arch 320. In certain implementations, the construct operation 260 places the denture arch 320 in the previously fabricated jig 600 to hold the denture arch 320 during the milling process. In other implementations, a technician may manually carve out the new gingival interface 325′.

The adjustment process 250 performs any appropriate completion procedures and ends at a stop module 262. Of course, the above recited steps need not be performed completely in the order listed. For example, a user may design the new gingival interface before filling the denture arch with new material.

While particular embodiments have been described above, it will be understood that by those skilled in the art that the disclosure is not limited by the embodiments or the particular devices disclosed and described herein. It will be appreciated that other devices that embody the principles of this disclosure and other applications therefor other than as described herein can be configured within the spirit and intent of this disclosure. For example, the design and manufacture system 500 described herein is provided as only one example of a denture design and manufacturing system that incorporates and practices the principles of this disclosure. Since many embodiments of the disclosure can be made without departing from the spirit and scope of the disclosure, the invention resides in the claims hereinafter appended.

1. A method of manufacturing dentures for a patient, the method comprising:
preparing a denture plan by positioning a plurality of tooth substitute electronic models relative to an electronic model of a first edentulous arch to form a first dentition model, the tooth substitute electronic models each having a root and a crown;
designing a first denture base to fit on the first edentulous arch, wherein designing the first denture base includes:
generating an electronic model of the first denture base having a first side and a second side,
defining holes in the first side, each hole corresponding to one of the tooth substitute electronic models of the first dentition model, each hole being sized to accommodate the root of the corresponding tooth substitute electronic model, and
defining a first gingival interface at the second side, the first gingival interface being configured to fit on a gingival surface of the first edentulous arch;
fabricating a first pattern of the first denture base based on the first denture base electronic model, the fabricated first pattern including a first side defining holes configured to receive the roots of the tooth substitutes and a second side configured to fit on the gingival surface of the first edentulous arch;
obtaining a plurality of tooth substitutes that correspond with the tooth substitute electronic models;
forming a first fabrication assembly by positioning the roots of the tooth substitutes in the holes defined in the first side of the first pattern; and
fabricating a first denture based on the first fabrication assembly, the first denture including the tooth substitutes positioned in accordance with the first dentition model.

2. The method of claim 1, further comprising:
obtaining positional information pertaining to the first edentulous arch of the patient; and
generating the electronic model of the first edentulous arch based on the obtained positional information.

3. The method of claim 2, wherein obtaining the positional information comprises intra-orally scanning the first edentulous arch of the patient.

4. The method of claim 2, wherein obtaining the positional information comprises scanning a casting of the first edentulous arch of the patient.

5. The method of claim 1, further comprising generating the tooth substitute electronic models based on positional data obtained by scanning the tooth substitutes.

6. The method of claim 1, further comprising retrieving the tooth substitute electronic models from an electronic library.

7. The method of claim 1, wherein obtaining the plurality of tooth substitutes comprises fabricating the plurality of tooth substitutes based on the tooth substitute electronic models.

8. The method of claim 1, wherein preparing the denture plan further comprises defining an occlusal plane on the first edentulous arch electronic model; wherein positioning the tooth substitute electronic models comprises positioning the tooth substitute electronic models based on a location of the occlusal plane relative to the first edentulous arch electronic model.

9. The method of claim 1, wherein the first edentulous arch is a maxillary arch.

10. The method of claim 1, wherein the first edentulous arch is a mandibular arch.

11. The method of claim 1, further comprising modifying the tooth substitutes to fit with the first pattern including:
generating a tool path along which the root of each tooth substitute is to be trimmed to fit the root within a corresponding hole of the first pattern;
designing a jig having a surface that defines a plurality of holes, each hole of the jig being sized and configured to receive the crown of one of the tooth substitutes, the holes being positioned to space the tooth substitutes in accordance with the first dentition model;
fabricating the jig;
positioning the tooth substitutes in the holes of the jig; and
milling the root end of each tooth substitute along the tool path.

12. The method of claim 11, further comprising:
scanning the jig to obtain positional information of the jig;
archiving the positional information of the jig; and
archiving the tooth path.

13. The method of claim 1, wherein fabricating the first denture based on the first fabrication assembly comprises:
sealing the tooth substitutes to the first pattern;
investing the pattern and tooth substitutes to form a casting mold of the first denture; and
casting the first denture using the casting mold.

14. The method of claim 1, further comprising:
filling in a gingival interface of the first denture, the gingival interface of the first denture being formed in accordance with the first gingival interface;
obtaining updated positional information of the first edentulous arch after the first edentulous arch has healed from surgery; and
forming a new gingival interface in the first denture based on the updated positional information to enable the first denture to fit on the first edentulous arch.

15. A jig comprising:
a jig base having a first side; and
a plurality of holes defined in the first side of the jig base, the holes being positioned in a dental arch configuration, each hole being sized to receive at least part of a crown of a tooth substitute so that a root of the tooth substitute extends upwardly from the jig base.

16. A denture pattern representing a denture arch to be manufactured, the denture pattern comprising:
a denture base formed from a consumable material, the denture base having a first side and a second side;
a plurality of tooth substitutes positioned on the first side of the denture base, the tooth substitutes being positioned in a dental arch configuration; and
a gingival interface defined by the second side of the denture base, the gingival interface being contoured to engage a gingival surface of a wearer of the denture arch.

17. The denture pattern of claim 16, wherein the tooth substitutes include roots that extend into the denture base.

18. The denture pattern of claim 17, wherein the first side of the denture base defines a plurality of holes into which the roots of the tooth substitutes are inserted.

19. The denture pattern of claim 18, wherein the tooth substitutes are sealed to the denture base using wax.

20. A method comprising:
obtaining a first denture arch including a denture base having a first side and a second side, the first denture arch including tooth substitutes attached to the first side of the denture base, the second side of the denture base defining a first gingival interface;
covering the first gingival interface with a material;
forming a second gingival interface into the material to form a modified denture arch.

21. The method of claim 20, wherein covering the first gingival interface with the material comprises filling the gingival interface of the denture base with acrylic.

22. The method of claim 20, wherein forming the second gingival interface into the material comprises milling the second gingival interface into the material.

23. The method of claim 20, further comprising:
obtaining an impression of an edentulous arch of a patient;
digitizing the impression; and
designing the second gingival interface based on the digitized impression.

24. The method of claim 23, further comprising:
temporarily installing the first denture arch with the first gingival interface on a patient; and
subsequently removing the first denture arch with the first gingival interface prior to obtaining the impression.
